(19) United States
(12) Patent Application Publication
(10) Pub. No.: US 2025/0285622 A1
(43) Pub. Date: Sep. 11, 2025

(54) CASCADED SPEECH RECOGNITION FOR ENHANCED PRIVACY

(71) Applicant: Adeia Guides Inc., San Jose, CA (US)

(72) Inventors: Markku Kylänpää, Helsinki (FI); Ville Ollikainen, Vihti (FI); Dhananjay Lal, Englewood, CO (US)

(21) Appl. No.: 18/599,600

(22) Filed: Mar. 8, 2024

(51) Int. Cl. G10L 15/26; G10L 13/08; G10L 15/22

(52) U.S. Cl. CPC G10L 15/26; G10L 13/08; G10L 15/22; G10L 2015/228

(57) ABSTRACT

Systems and methods for enabling enhanced privacy communication between a user device and a target service are described. The target service receives a user query and determines a first voice response. The target service generates the first voice response by splitting a text response into segments such that any sensitive information is divided into multiple smaller chunks or segments, converts the segments into voice prompts using multiple TTS converters, and combines the voice prompts to generate the voice response. The target service transmits the voice response to the user device. The user device then receives a user voice input and transmits it to the target service. The target service splits the user voice input into segments such that any sensitive information is divided between multiple segments, converts the segments into text input segments using multiple STT converters, and combines the converted segments to generate a text input.

### FIELD OF INVENTION

The present disclosure relates to enabling enhanced privacy for a conversation between a person using a voice assistant device and a target service providing information to the user. For example, the present disclosure describes techniques for converting portions of the conversation from speech to text and/or from text to speech using multiple different converters, so as to ensure that no single converter has access to the full conversation.

### SUMMARY

Voice assistant technologies like Amazon Alexa have become popular as they allow users to use speech communications to access various information services. Some voice assistant systems rely on cloud services to run speech recognition and natural language processing to interpret and act on user speech inputs. The use of cloud services helps to keep the system requirements of the end-user device low, which in turn enables the end-user device to remain affordable.

In an example voice assistant scenario, a user may input a request or command to their end-user device. That input is transmitted to a cloud service or voice-assistant service run by a service provider (e.g., Amazon), which in turn identifies the relevant skill and provides a structured request of the user's input to that skill. A “skill” may refer to a voice activated application that can be controlled via a user's voice from their user device, adds capabilities to the voice activated device, and/or is a third-party service extension to the ecosystem of the voice activated device. For example, a skill may be a trivia game (provided by a third party distinct from the service provider) accessible via the user device and controlled via the user's voice. After receiving the structured request from the service provider, the skill then processes the structured request and returns a text response and/or graphical response to the service provider (e.g., Amazon). The service provider then converts the text response into a speech response and transmits the speech response and graphical response to the user device for presentation to the user.

However, the use of cloud-based processing of the user inputs by the service provider brings significant drawbacks by exposing the user voice interactions with the voice assistant. For example, the service provider may use the user's interactions with the voice assistant to profile the user and/or learn information about the user that the user does not intend to share with the service provider. The user may have no control over how their data is used, and the user's information may end up being sold to third parties. Additionally, the service provider may function as a single point of failure if an unauthorized party gains access to the stored voice dialogs. Further, the service provider may face liability if there is a data breach, particularly if a third-party service is involved (e.g., a bank, health service, etc.).

One approach for addressing some of these issues is to allow the user to delete old conversations. However, this works only if the user is proactive, as the mechanism for deletion takes place behind the scenes at the service provider, and this mechanism still fails to solve the issues of profiling, centralization of storage, and liability for breaches. Another approach includes allowing for local speech-to-text conversion at the user device rather than in the cloud. This approach, however, requires increased costs and significant computing resources at the user device, may cause the user devices to become prohibitively expensive, and/or a user's locally stored data may be more susceptible to hackers. Additionally, local conversion at the user device may limit the upgrade capabilities of the device, preventing the device from taking advantage of advances in conversion technology.

Thus, there is a need for a solution that enables the features of voice assistant services, while keeping the user device lightweight and also avoiding exposure of an entirety of the user's voice interactions to a single centralized speech-to-text converter and/or a single text-to-speech converter.

With the above noted issues in mind, an example method of this disclosure involves a target service (e.g., a bank service, doctor service, etc.) receiving a first user voice input and generating a first voice response. The target service then transmits the first voice response to a user device via a connection established between the target service and the user device, without the service provider acting as an intermediary for speech-to-text (STT) or text-to-speech (TTS) cloud services. This removes the service provider from the conversation, thereby preventing the service provider from storing the conversation. The conversation between the user device and the target service is segmented into multiple segments, which are sent to multiple distinct STT and/or TTS converters as appropriate, such that no single converter has access to the full conversation. As a result, the functions of the voice assistant service remain available to the user, and the user device can remain lightweight because the speech and text conversion remains in the cloud. The use of multiple STT and/or TTS converters also prevents a single converter from having access to the full conversation, thereby reducing the risk of any third party gaining access to private information shared during the conversation.

In one example, a method disclosed herein includes a target service receiving a first user voice input. The target service may then generate a first text response based on the first user voice input. The first text response may be used to generate a first voice response, such as by using one or more TTS converters, which may be controlled by the target service, the voice assistant service, or some other entity. The target service then transmits the first voice response to a user device via a connection established by a voice assistant service between the user device and the target service. The target service then receives, from the user device, a second user voice input and generates a second user text input in relation to the second user voice input. In this example, generating the second user text input includes generating a plurality of second user voice input segments based on the second user voice input and transmitting each respective second user voice input segment of the plurality of second user voice input segments to a different speech-to-text converter, wherein the different speech-to-text converters generate a plurality of second user text input segments. Generating the second user text input then includes combining the plurality of second user text input segments. The target service then generates a second voice response in relation to the second user text input and transmits the second voice response to the user device.

In some embodiments, in the techniques disclosed herein, the target service also receives, from the voice assistant service, a request to initiate a conversation between the user device and the target service, wherein the first user voice input comprises the request to initiate the conversation. Additionally, the first user voice input may include a wake phrase and a target service identifier. For example, the first user voice input may be, for example, “Hey assistant, call my bank.” The phrase “call my bank” may act as a request to initiate a conversation between the user device and the target service (e.g., the bank). Additionally, the term “my bank” may refer to information associated with the user in a user profile, such that the term “my bank” acts as a target service identifier for a bank associated with the user. The target service (e.g., bank) may be identified based on the target service identifier in the user voice input.

In some embodiments, the target service may generate the first voice response using a plurality of text-to-speech converters. For instance, generating the first voice response may include determining a first text response, and segmenting the first text response into a plurality of first text response segments. The method then includes transmitting each respective first text response segment of the plurality of first text response segments to a different text-to-speech converter, wherein the different text-to-speech converters generate a plurality of first voice response prompts, and then combining the plurality of first voice response prompts to generate or form the first voice response.

In some embodiments, a response from the target service (and/or an input from the user) may include sensitive or confidential information (e.g., account numbers, health information, financial information, biometric information, genetic information, personally identifiable information (PII), voting information, or any other suitable confidential or sensitive information, or any combination thereof). The target service may identify this sensitive information and may split up the sensitive information into two or more segments. Each segment including a portion of the sensitive information may be sent to a different TTS or STT converter so there is a reduced risk of any single converter obtaining all of the sensitive information.

In some embodiments, to support the TTS and/or STT converters in converting a text response into a plurality of voice response prompts, the target service may include output parameters to be used by the converters. These output parameters may ensure that each TTS converter returns a voice response prompt that matches in output voice, cadence, and/or various other features. Because multiple TTS converters may be used, it may be useful to ensure that the voice response prompts all sound the same, so the segments of the response have continuity.

In some embodiments, the method disclosed herein further includes determining whether the target service comprises a text-to-speech converter, and/or whether the target service has or controls its own TTS converter. If it is determined that the target service does not comprise a TTS converter (e.g., if the target service does not have or control its own TTS converter), the method includes generating, by the target service, the first voice response using the different TTS converters. Additionally, the method may further include determining whether the target service comprises a STT converter (e.g., whether the target service has or controls its own STT converter). If it is determined that the target service does not comprise a STT converter (e.g., if the target service does not have or control its own STT converter), the method includes generating, by the target service, the second user text input using the different STT converters.

In some embodiments, each of the different TTS and/or STT converters may be operated independently from the target service. Additionally, each TTS and/or STT converter may be independent from the others, and/or some or all of the TTS and/or STT converters may be operated independently from the others. Still further, one or more of the TTS and/or STT converters may be controlled by the target service itself.

In some embodiments, the method disclosed herein may further include determining whether an input request to enable enhanced privacy for the connection between the user device and the target service has been received. For instance, the user may say “Hey assistant, call my bank with enhanced privacy,” or may have a default selection of enhanced privacy activated for certain target services. If the enhanced privacy is not activated, the conversation between the user device and the target service may take place using a single TTS and/or STT converter, which may be controlled by the target service, by the user device, by the voice assistant service, or by some other entity. However, if the user activates enhanced privacy, the conversation may be segmented into multiple text and/or voice segments, which are converted using multiple distinct or independent TTS and/or STT converters.

In some embodiments, the user device disclosed herein may determine one or more candidate locations in the user voice input for segmentation. That is, the user device may analyze the user's voice input (e.g., utterances) using voice activity detection and/or pause detection to identify likely positions in the voice input where segmentation may be performed. The candidate locations may then be sent to the target service along with the voice input (e.g., as metadata), and the target service may segment the voice input based on the candidate locations for segmentation.

In some embodiments, the target service may perform post-processing after combining the plurality of voice response prompts to generate the voice response, to correct errors. When voice prompts received from the TTS converters are combined, there may be artifacts or other errors introduced. For example, the spacing between words at the end of a first segment and the beginning of a second segment may sound awkward when the segments are combined. Further, given only limited information, a given segment may include a homonym that does not match the context of the response. Post-processing may be performed by the target service in order to correct these issues. Additionally or alternatively, post-processing may be performed after combining text response segments from the STT converters.

In some embodiments, the target service generating the second voice response may include determining a second text response based on the second user text input, and segmenting the second text response into a plurality of second text response segments. The method disclosed herein may then include transmitting each of the plurality of second text response segments to a different text-to-speech converter, wherein the different text-to-speech converters generate a plurality of second response voice prompts, and combining the plurality of second response voice prompts to generate the second voice response.

In some embodiments, the number of different TTS and/or STT converters used in generating the first voice response may be different from the number used in generating the second voice response. Additionally, the number of different TTS and/or STT converters used in generating the second user text input may be different from the number used in generating a subsequent user text input. That is, as the conversation between the user device and the target service carries on, the number of STT and/or TTS converters used for each interaction may vary.

It should be appreciated that embodiments of the present disclosure enable verification that the user's inputs have been split and are not being shared with a voice assistant service. An ethical hacker may analyze the communications, in particular those with the user device, which enable verification that the user's sensitive information is not being shared.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a block diagram for a process of establishing communication between a user device and a target service using enhanced privacy, in accordance with some embodiments of the disclosure;

FIG. 2 shows a sequence diagram for initiating a conversation between a user device and a target service, in accordance with some examples of the disclosure;

FIG. 3 shows a sequence diagram following the sequence diagram of FIG. 2 for generating a voice response using multiple text-to-speech converters, and transmitting the voice response from the target service to the user device, in accordance with some examples of the disclosure;

FIG. 4 shows a sequence diagram following the sequence diagram of FIG. 3 for receiving a user voice input and converting the user voice input into a text input using multiple speech-to-text converters, in accordance with some examples of the disclosure;

FIG. 5 shows a sequence diagram following the sequence diagram of FIG. 4 for generating a second voice response using a plurality of text-to-speech converters and transmitting the second voice response from the target service to the user device, in accordance with some examples of the disclosure;

FIG. 6 shows illustrative user equipment devices, in accordance with some embodiments of this disclosure;

FIG. 7 shows illustrative systems, in accordance with some embodiments of this disclosure;

FIG. 8 is a flowchart of an example process for communication between a user device and a target service, in accordance with some embodiments of the disclosure.

### DETAILED DESCRIPTION

Cloud services like Amazon Alexa provide an ecosystem for third-party services to operate, allowing those third-party services to integrate with the ecosystem. Third-party services may be referred to using various different terms, such as third-party services, services, extensions, or skills. For instance, in the Amazon ecosystem that includes Amazon Alexa, these third-party services are called Alexa Skills. These services may bring additional security and privacy concerns as end-users may not have clear visibility and control of how the service operates, how user inputs are processed, what the services do with user data, and more.

In an example interaction with a cloud service like Amazon Alexa, a user may input a voice command to the user's device requesting some action from a particular skill. The cloud service operated by Amazon may then parse the input voice command and send a structured representation of the voice command to the desired skill, which may include performing speech-to-text (STT) and/or text-to-speech (TTS) functions. The user's device and cloud service (i.e., Amazon) may eavesdrop into the entire conversation between the user and the skill as a price for performing the STT and TTS functions.

As noted above, users may not want the voice assistant cloud service to listen in on their conversation with the third-party service, due to privacy concerns. Additionally, the voice assistant cloud service may not want to listen in on these conversations either, due to liability associated with privacy breaches.

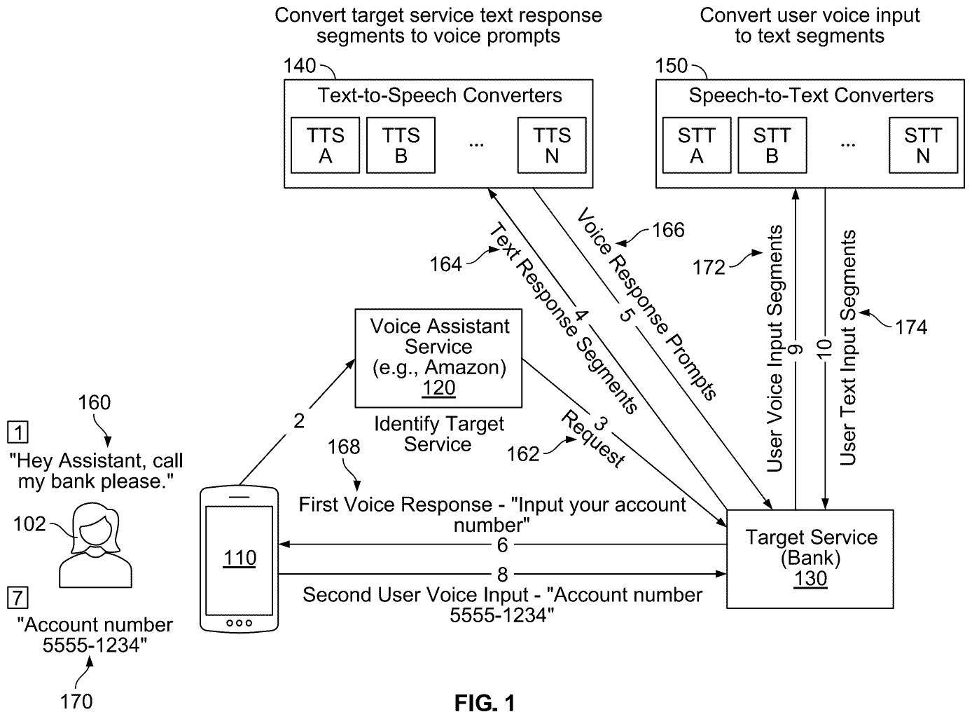

With these issues in mind, FIG. 1 illustrates an example scenario in which a user 102 communicates with a target service 130 using enhanced privacy, such that the voice assistant service 120 cannot listen to the full conversation between the user device 110 and the target service 130. As discussed in further detail below, after an initial setup by the voice assistant service 120, the user's voice inputs are segmented and converted to text using multiple STT converters, such that no single converter has access to the entire voice input. Similarly, each response by the target service 130 may be segmented and converted to voice output using multiple TTS converters, such that no single converter has access to the entire response.

Regarding FIG. 1, and in particular, at step 1, user device 110 receives, from user 102, a first voice input 160 (e.g., “Hey assistant, call my bank please.”). For example, such first voice input may be received by a microphone of user device 110. As shown, the first voice input 160 may include a wake phrase and a request to access a target service, e.g., target service 130 (e.g., a bank).

At step 2, the first voice input 160 is transmitted to the voice assistant service 120, which may convert the voice input into text using one or more computer-implemented techniques (e.g., natural language processing (NLP) techniques, transcription techniques, and/or machine learning techniques). Voice assistant service 120 may include one or more STT and/or TTS converters, which enable various functions by the voice assistant service itself (e.g., separate from any third-party service).

At step 3, the voice assistant service 120 identifies the target service 130 requested by the user 102 in the first voice input 160. The voice assistant service 120 may use a STT converter and may analyze the input to determine which third-party service the user is requesting a conversation with. For example, to determine which target service user 102 is requesting to access, voice assistant service 120 may compare one or more portions of the received first voice input 160 to a data structure storing identifiers of target services, and/or may reference a profile of user to determine which bank(s) user 102 has an account with. The voice assistant service 120 may then transmit a request 162 to the identified target service 130 to establish a direct connection between the target service 130 and the user device 110. This may include establishing a new communication channel (e.g., a logical IP channel), sharing IP addresses with the target service 130 and/or user device 110, and/or informing user device 110 and/or target service 130 that a network socket or endpoint is becoming available, and/or various other actions to facilitate establishing a communication channel between the user device 110 and target service 130. The voice assistant service 120 may then be removed from the rest of the conversation session.

At step 4, the target service 130 determines a text response to be sent to the user device 110 in response to the user's voice input. The target service may split or divide the text response into a plurality of segments 164 and transmit those text segments 164 to a plurality of TTS converters 140 such that each TTS converter receives only a portion of the text response.

At step 5, the TTS converters 140 convert the text response segments 164 into respective voice response prompts 166. The TTS converters 140 then transmit the voice response prompts 166 back to the target service 130. In some embodiments, one or more of the TTS converters 140 may be operated by or controlled by target service 130, and/or the TTS converters 140 may each be operated by or controlled by independent entities or parties, and/or the TTS converters 140 may each be associated with a different content delivery network (CDN). Each STT and/or TTS converter may be a separate service associated with a CDN. The target service may consider the location of the STT and/or TTS converters (e.g., edge computing) so as to select converters that are located close to the target service to minimize or reduce latency.

At step 6, the target service 130 receives and combines the voice response prompts 166 to generate a voice response 168 (e.g., “input your account number”). The target service 130 may then transmit the voice response 168 to the user device 110, bypassing the voice assistant service 120. The user device 110 then outputs the voice response 168 via a speaker of user device 110, so the user can hear the response.

At step 7, the user provides another voice input 170 responding to the target service 130. In the illustrated example, the user provides a voice input 170 including an account number (e.g., “account number 5555-1234” in response to the first voice response 168 of “Input your account number”). The user device 110 may also identify one or more candidate positions in the user's voice input at which the voice input 170 may be split or divided into segments. For instance, the user device 110 may use voice activity detection and/or pause detection to identify pauses in the voice input 170 that may correspond to breaks in the user's speech, marking the separation between words, phrases, sentences, or some other segment of the voice input. In some embodiments, the pause detection may be performed based at least in part on energy thresholding, pitch detection, zero-crossing rate, periodicity measure, cepstral features, spectrum analysis, linear prediction coding (LPC), or based on any other suitable technique or factors, or any combination thereof. In some embodiments, pause detection may be used to avoid splitting speech fragments during word utterances.

At step 8, the user device 110 transmits the second user voice input 170 to the target service 130, again bypassing the voice assistant service 120. The user device 110 may also transmit the candidate locations for segmentation, which may be stored and/or transmitted as metadata along with the second user voice input 170.

At step 9, the target service 130 receives the second user voice input 170 (and In some embodiments also receives the candidate locations for segmentation). The target service 130 then may split or divide the second user voice input 170 into segments 172. For example, the target service 130 splits the second user voice input 170 such that any sensitive information in the voice input is split into multiple segments. For example, if the second user voice 170 input is “account number 5555-1234,” it may be split into a first segment including a first portion of the account number (e.g., “account number 5555”), and a second segment including a second portion of the account number (e.g., “1234”). The segments may be the same size, or may be different sizes. The target service 130 may then transmit the second user voice input segments 172 to the STT converters 150, again ensuring that any sensitive information in the second user voice input is split or divided into multiple segments that are each sent to a different STT converter. In some embodiments, one or more of the STT converters 150 may be operated by or controlled by target service 130, and/or the TTS converters 140 may each be operated by or controlled by independent entities or parties, and/or the TTS converters 140 may each be associated with a different content delivery network (CDN). Similar to the disclosure above with respect to step 5, the target service may select one or more STT and/or TTS converters based on their locations (e.g., edge computing), so as to minimize or reduce latency.

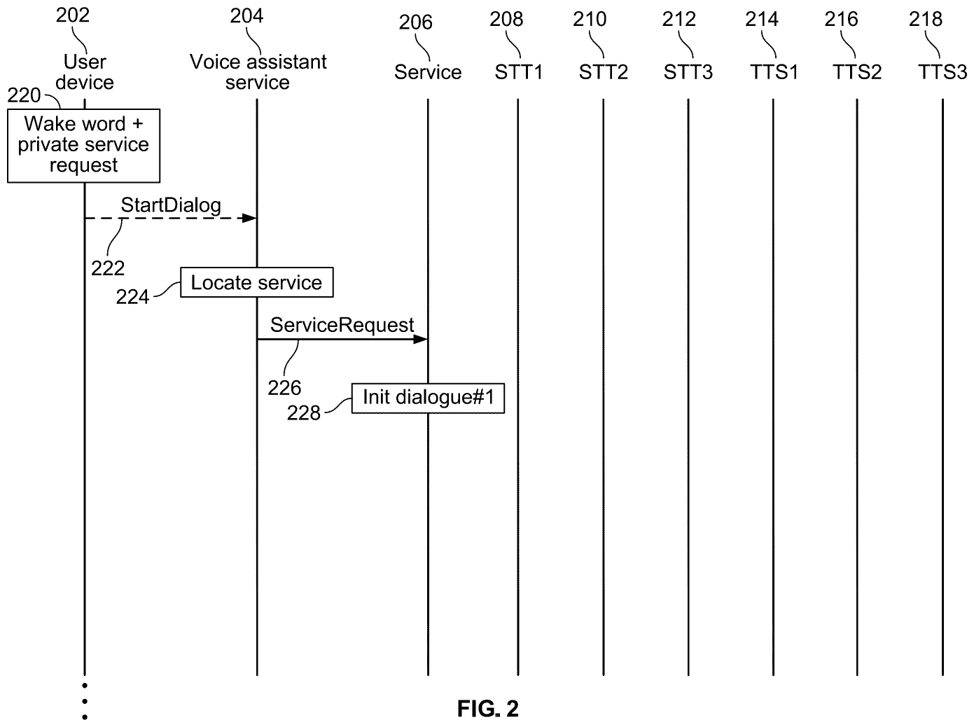

At step 10, the STT converters 150 convert the second user voice input segments 172 into respective second user text input segments 174. The STT converters then transmit the second user text input segments 174 to the target service 130. The target service 130 then combines the second user text input segments 174, and determines an appropriate second text response to send to user device 110. The target service 130 may then repeat steps 4-10 to provide voice responses to the user device 110, and receive voice inputs from the user 102, until the conversation is completed. The steps illustrated in FIG. 1 are described in further detail below, with respect to FIGS. 2-5.

FIGS. 2-5 illustrate example sequence diagrams showing the steps and communications between various devices and systems to provide enhanced privacy for a user according to embodiments of the disclosure. FIGS. 2-5 include a user device 202, a voice assistant service 204, a target service 206, a plurality of STT converters 208-212, and a plurality of TTS converters 214-218 (which may correspond to user device 110, a voice assistant service 120, a target service 130, a plurality of STT converters included at 140, and a plurality of TTS converters included at 150 of FIG. 1, respectively). Each of these devices and/or systems may operate within an ecosystem that manages the voice assistant service and enables various third parties to provide their own services. For example, the ecosystem may be a large cloud and/or application ecosystem provider like Amazon, Google, Microsoft, Apple, or Alibaba, or any other suitable ecosystem. These entities may function as a gatekeeper to the ecosystem, accepting services and setting requirements and/or certification steps for user devices.

User device 202 may include a voice assistant device like an Amazon Echo™ or Google Home™, a mobile phone, a tablet, a smart TV, and/or any other suitable device with the ability to receive voice inputs. In some embodiments, the user device 202 may be listening all the time and can be triggered by a wake word or phrase to interpret a voice command from a user. For example, user device 202 may utilize one or more voice activity detection (VAD) techniques, such as, for example, the G.729 VAD algorithm, for wake word detection and/or keyword spotting.

The voice assistant service 204 may be a service controlled by the ecosystem that manages the platform (e.g., Amazon, etc.). The voice assistant service 204 may orchestrate user communication with the target service 206, including initiating communication with the target service 206, establishing a communication channel between the user device 202 and the target service 206, passing various data to user device 202 and/or target service 206, and more. In some circumstances, such as when enhanced privacy is disabled, the voice assistant service 204 may perform STT and/or TTS conversions by itself (e.g., without using the STT converters 208-212 and/or TTS converters 214-218).

The target service 206 may be a third-party service that the user desires to access and communicate with. For example, the target service 206 may be a doctor's office, medical service, therapist, bank, financial service, mental health service, and/or any other suitable third-party service (or any combination thereof) that can communicate with a user. In some embodiments, the target service 206 may be pre-registered with the voice assistant service 204, and/or the user may have a profile or account established with the target service 206.

The STT converters 208-212 may perform speech-to-text conversion on segments of voice inputs. Each converter may be independently controlled and operated (e.g., separate from the voice assistant service 204 and/or target service 206). In other embodiments, one or more STT converters may be controlled by the voice assistant service 204 and/or the target service 206. Each STT converter 208-212 may use NLP and/or other processing techniques to convert input speech or voice into text.

The TTS converters 214-218 may perform text-to-speech conversion on segments of text responses from the target service 206. Each converter may be independently controlled and operated (e.g., separate from the voice assistant service 204 and/or target service 206). In other embodiments, one or more TTS converters may be controlled by the voice assistant service 204 and/or the target service 206. Each TTS converter may use one or more computer-implemented processing techniques to convert input text into a voice prompt. The voice prompts from each TTS converter may be sent to another device or system for output to a user via a speaker, as discussed in further detail below.

FIG. 2 illustrates a sequence diagram showing the initiation of a conversation between a user device 202 and a target service 206. At 220, the user of the user device 202 provides a voice input to the user device 202. The voice input may include a wake word or wake phrase (e.g., “OK Google,” “Hey Alexa,” “Hey Siri,” etc.). The user device 202 may use NLP or any other suitable processing technique to identify the wake word or phrase, and then listen for and record further voice input from the user requesting performance of one or more actions. After identifying the wake word, the user device 202 may listen for and record audio until an end of the voice input is somehow detected, such as, for example, by listening for a threshold duration of silence.

The voice input may also include a private service request. The private service request may be a request to begin a conversation with a target service, such as a bank, therapist, doctor, healthcare service, etc. The target service may be identified in the voice input by name or some other identifier, which may be referred to herein as a target service identifier.

In some embodiments, the voice input from the user may also include a request to enable or use enhanced privacy measures. With enhanced privacy enabled, the conversation between the user device 202 and the target service 206 may make use of multiple STT converters and/or TTS converters as described herein. Without enhanced privacy enabled, the conversation may use a single STT or TTS converter, and/or the voice assistant service (e.g., Amazon) may perform the STT and/or TTS conversions itself. In some embodiments, the request to enable or use enhanced privacy measures may be a part of the user's voice input (e.g., “Call my bank with enhanced privacy.”). In other embodiments, enhanced privacy may be a selectable setting in the user's profile, or it may be enabled by default; by a user selection, gesture, or other input; based on the identity of the target service (e.g., a request to initiate a conversation with target service A automatically causes enhanced privacy to be enabled); based on the type of service requested (e.g., a request to initiate a conversation with any target service in a financial or healthcare category automatically causes enhanced privacy to be enabled); and/or based on some other trigger. In some embodiments, the user may have a different wake work or phrase depending on whether the user wants to use enhanced privacy or not (e.g., “OK Google” is a default wake phrase without enhanced privacy, while “OK Privacy” wakes the user device with enhanced privacy automatically enabled).

In some embodiments, only certain portions of the conversation between the user device 202 and the target service 206 may be performed using enhanced privacy. For instance, the user may specify one or more portions of the conversation that require enhanced privacy, such as by saying “Private start,” followed by the message the user wishes to send to the target service 206, and then followed by “Private end.” In other embodiments, the user device 202, target service 206, and/or one or more other systems or devices may automatically identify certain portions of the conversation between the user device 202 and the target service 206 that require enhanced privacy, while other portions do not.

In some embodiments, the user may have the option to select which TTS and/or STT converters are used, how many converters are used, the properties of the converters (e.g., male or female voice, etc.), and/or other features of the STT and/or TTS converters described herein. An input may be made via a user interface of the user device indicating a set of TTS and/or STT converters (and/or criteria for the converters), and the user device may transmit the indication of the set of TTS and/or STT converters to the target service.

At 222, the user device 202 transmits the voice input from the user to the voice assistant service 204. As noted above, the voice input may include a request to start an enhanced privacy conversation with a target service 206. The voice assistant service 204 may analyze the voice input and identify the target service using the target service identifier included in the voice input, using a standard voice assistant STT mechanism without enhanced privacy (e.g., using a single STT converter, or one or more STT converters controlled directly by the voice assistant service).

At 224, the voice assistant service 204 identifies the target service 206 from the voice input. This may include using one or more STT converters to process voice input and identifying a target service. The target service may be pre-registered and already linked to a user account using a secure mechanism such as OAuth 2.0.

At 226, the voice assistant service 204 transmits a service request to the target service 206. The service request may be a structured request including various pieces of information about the user device 202, the user of the user device 202, communication parameters, and more. The voice assistant service 204 may pass IP addresses to both the user device 202 and the target service 206 to inform them that a connection is going to be established.

At 228, the target service 206 receives the service request and initiates a new service dialog with the user device 202 based on the received request. At this point, the voice assistant service 204 is removed from the conversation, and a connection between the user device 202 and the target service 206 is established without the voice assistant service 204 as an intermediary.

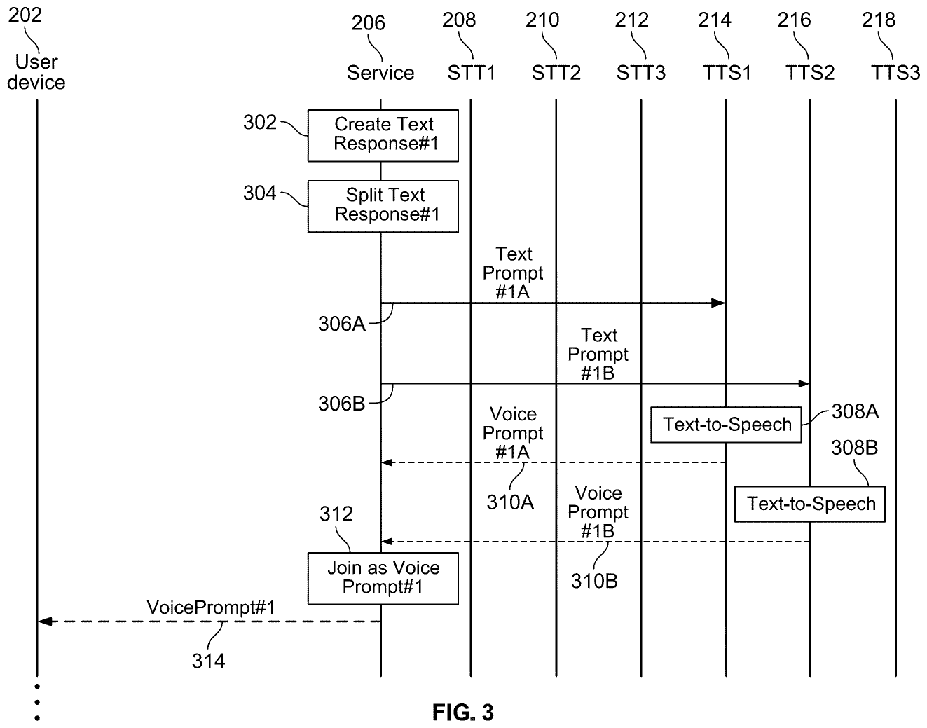

FIG. 3 illustrates a portion of the process following that shown in FIG. 2. In particular, FIG. 3 illustrates the steps in the process immediately following step 228 of FIG. 2, in which the target service 206 has initiated a new service dialogue with the user device 202. That is, once the target service 206 receives the initial request from the user to establish a connection (as shown in FIG. 2), FIG. 3 illustrates how the target service 206 provides a response to the user device 202. At a relatively high level, FIG. 3 illustrates how the target service 206 creates a text response based on the voice input from user. The text response may include sensitive information (e.g., user data), so the target service 206 splits or divides the text response into multiple segments with the sensitive information being split among two or more different text response segments. Each text response segment is sent to a different TTS converter (e.g., 214-218) for conversion to a voice prompt. The target service 206 then joins voice prompts into a voice response, which is transmitted to the user device 202. No single entity aside from the target service 206 itself has access to the entire response.

At 302, the target service 206 creates a first text response. The first text response may be a response to the user's first voice input. The first text response may be generated using artificial intelligence (e.g., an AI chatbot operated by the target service), and/or may include sensitive information (e.g., user data, account number, health information, etc.). In some embodiments, the first text response may be a simple greeting, such as “Hello, how can I help you?” The content of the first text response may be dependent on the first voice input from the user device 202. The first text response may also include an indication that enhanced privacy is enabled, such as by including the text “Privacy mode is on.”

At 304, the target service 206 splits or divides the first text response into a plurality of first text response segments. In illustrated example, there are two first text response segments, segment A and segment B. However, it should be appreciated that the first text response may be split into any number of segments, and FIG. 3 includes two segments for illustrative purposes only. The target service 206 may split the first text response into segments based on the content of the first text response. For example, if the first text response includes sensitive information, the target service 206 may split the first text response to ensure that the sensitive information is split between two or more different segments, and no single segment includes all of the sensitive information. In some embodiments, the target service 206 may perform pre-processing on the first text response to identify sensitive information based on detecting certain terms, certain categories of information, an account balance, symptoms of a health problem, etc. In some embodiments, the pre-processing may include identifying topic-critical phrases and/or splitting subjects from verbs, to help prevent the overall meaning of an input or response from being gleaned from a portion thereof. The target service 206 may then identify the best positions in the first text response for segmentation. In some embodiments, the target service 206 may split the first text response based on the length of the first text response, the number of TTS converters available, the length or amount of sensitive information in the first text response, the placement of sensitive information within the first text response, or based on some other criteria.

At 306A and 306B, the first text response segments (e.g., segments A and B) are sent to different respective TTS converters. In the illustrated example of FIG. 3, segment A is sent to TTS converter 214, while segment B is sent to TTS converter 216. In some embodiments, the TTS converters may each be operated or controlled by the target service 206. In other embodiments, one or more of the TTS converters may be controlled or operated independently from the target service 206. In still other examples, all of the TTS converters may be controlled or operated independently from the target service 206. Various examples may include any combination of control of the TTS converters by the target service 206 and/or independently from the target service 206.

In some embodiments, each first text response segment may be sent to a different TTS converter. In other embodiments, two or more segments may be sent to the same TTS converter. The target service may use any combination of TTS converters, such as by sending segments A and C send to a first TTS converter, and sending segments B and D to a second TTS converter. In some embodiments, non-adjacent segments may be sent to the same TTS converter. In some embodiments, segments may be sent to TTS converters based on the principle that no single TTS converter receives all of the sensitive information in the first text response segments.

In some embodiments, the process may include determining whether the target service 206 includes one or more TTS converters (e.g., operates or controls one or more of the TTS converters). If the target service 206 does not include any TTS converters, the target service may transmit the first text response segments to the different TTS converters 214-218. Alternatively, if the target service 206 does include one or more TTS converters 214-218, only that converter or set of converters may be used.

The target service 206 may transmit the first text response segments to the respective TTS converters along with one or more output parameters. The output parameters may specify how the TTS converters should process the first text response segments, to ensure that there is continuity of voice, tone, pitch, volume, accent, etc., in the corresponding output voice prompts from each TTS converter. The target service may want to avoid the discontinuity of having a first portion of the voice response being a male voice while a second portion is a female voice.

At 308A and 308B, TTS converters 214 and 216 convert the respective first response segments into voice prompts A and B. This may be done using any suitable processing technique. At 310A and 310B, the TTS converters 214 and 216 transmit voice prompts A and B to the target service 206.

At 312, the target service 206 joins together the voice prompts A and B received from the TTS converters 214 and 216, to generate a first voice response. The target service 206 may also perform post-processing on the voice prompts, and/or the first voice response after the voice prompts are joined. Different TTS converters may have different operational parameters that affect the output voice prompts, such as the voice gender, the length of pauses in each prompt, and more. When combined, the voice prompts may introduce awkward pauses or other artifacts, because each TTS converter is privy to only a portion of the full response. As a result, each TTS converter may incorrectly assume what the other segments may include (e.g., what the next adjacent segment includes), and thus incorrectly convert a given text response segment into a voice prompt. The post-processing by the target service may remove awkward pauses, ensure uniformity of voice, and/or otherwise correct any issues with the first voice response that may have been caused by splitting the text response into segments and separately converting the segments to voice prompts.

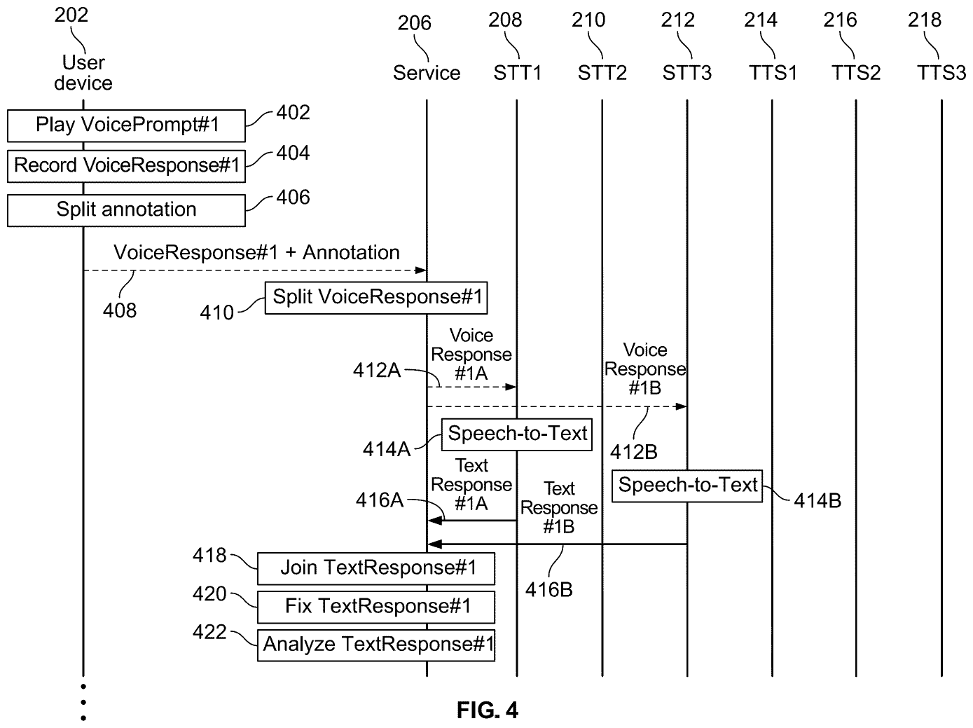

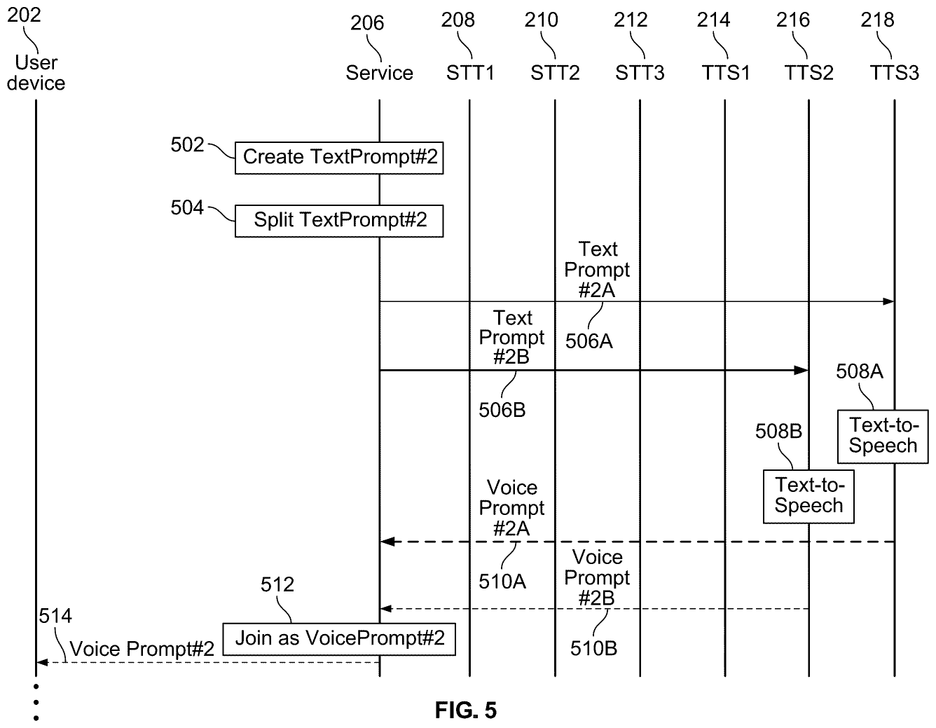

At 314, the target service 206 transmits the first voice response to the user device 202. The first voice response may be transmitted via the communication channel established between the target service 206 and the user device 202 by the voice assistant service 204 in FIG. 2. In some embodiments, the target service 206 may also transmit an indication of whether sensitive information is expected from the user in a next user voice input. For example, if the target service 206 first voice response is “Please input your account number,” the target service 206 may expect the user's next voice input to include the requested account number. The target service 206 may provide an indication to the user device 202 along with the first voice response, so that the user device 202 can take appropriate action to maintain the privacy of the sensitive information, as discussed in further detail below with respect to FIG. 4.

FIG. 4 illustrates a portion of the process following that shown in FIG. 3. In particular, FIG. 4 illustrates the steps in the process following step 314 of FIG. 3, in which the target service 206 transmits the first voice response to the user device 202. That is, once the target service 206 transmits the first voice response to the user device 202 (as shown in FIG. 3), FIG. 4 illustrates how the user inputs a second user voice input that is received and analyzed by the target service using multiple STT converters. At a relatively high level, FIG. 4 illustrates how the user device 202 may output the first voice response from the target service 206, and then listen for a second user voice input. The user device 202 then transmits the second user voice input to the target service 206, which splits or divides it into segments. The segments are sent to different STT converters such that no single STT converter receives the full input, and the STT converters return corresponding text input segments. The text input segments are then joined, processed, and analyzed by the target service 206 to determine an appropriate action or response.

At 402, the user device 202 outputs the first voice response to the user, the voice response having been received from the target service 206 at step 314 of FIG. 3. The user device 202 may include a speaker, which may output the first voice response. As noted above, the first voice response may be generic, such as the greeting “How may I help you?” The first voice response may also include or may request sensitive information from the user (e.g., “Your account balance is X,” “Please enter your account number,” etc.). The first voice response may also indicate whether enhanced privacy is enabled or not, thereby informing the user whether the conversation will proceed using multiple different TTS and/or STT converters.

At 404, the user inputs a second user voice input. The second user voice input may be input to a microphone of the user device 202 or connected to the user device 202. At 406, the user device 202 may perform an analysis of the second user voice input to identify one or more candidate locations for segmentation of the second user voice input. That is, the user device 202 may identify candidate locations in the second user voice input that are ideal for splitting it into segments. The user device 202 may perform voice activity detection, pause detection, or any other suitable analysis technique with respect to the second user voice input to identify pauses, breaks, spacing between words, and/or other features that may be used for segmentation purposes. Additionally, the user device 202 may identify sensitive information (or likely sensitive information) in the second user voice input based on the indication received from the target service along with the first voice response at step 314 of FIG. 3. For example, the first voice response from the target service 206 may include an indication that the second user voice input is likely to include sensitive information, such as an account number. This indication may also identify some expected feature of the second user voice input, such as an expectation that the second user voice input will include an account number (e.g., an eight-digit number). The user device 202 may use this indication (and/or other information) to predict that the second user voice input will include sensitive information, as well as one or more expected features of the sensitive information such as a voice input comprising an eight-digit number will contain. The user device 202 may then identify one or more candidate locations in the second user voice input for segmentation based on this indication and expected content. While the user device 202 may not understand the content of the second user voice input (since the user device merely records the input but does not convert to text), the user device 202 may look for an expected pattern or fingerprint in the second user voice input that matches the expected sensitive information (e.g., the expected eight-digit account number). This sensitive information may have a signature based on the expected cadence of a person speaking an account number, which may be used to identify the position of the sensitive information within the second user voice input. The user device 202 may then purposefully select candidate locations for segmentation in the second user voice input that, if used, would result in splitting or dividing the sensitive information into two or more segments.

In some embodiments, in response to receiving an indication that the second user voice input is likely to include sensitive information, the user device 202 may increase the number of candidate locations for segmentation or decrease the resulting segment size.

After identifying the candidate locations for segmentation, the user device 202 may store the candidate locations as metadata along with the second user voice input.

At 408, the user device 202 transmits the second user voice input to the target service 206. The user device 202 may also transmit the candidate locations for segmentation to the target service 206, separately or as metadata along with the second user voice input.

At 410, the target service 206 splits or divides the second user voice input into a plurality of second user voice input segments. The target service may split or divide the second user voice input based on the candidate locations identified by the user device 202. In some embodiments, the target service 206 may perform its own analysis of the second user voice input to identify a separate set of candidate locations for segmentation, and may split or divide the second user voice input based on those candidate locations irrespective of the first set of candidate locations identified by the user device 202. Alternatively, the target service may perform a supplemental analysis of the second user voice input to identify a second set of candidate locations, and may use both the first set of candidate locations identified by the user device 202 as well as the second set of candidate locations identified by the target service itself.

At 412A and 412B, each of the second user voice input segments is sent to a respective STT converter. As shown in FIG. 4, a first segment A is sent to STT converter 208, and a second segment B is sent to STT converter 212. It should be appreciated that the number of segments and the selection of STT converters is just one example. Other numbers of segments, converters, and combinations of segments and converters may be used. For example, there may be a single segment to single STT converter arrangement (e.g., a one-to-one ratio), multiple segments to one or more STT converters (e.g., segments A and C sent to STT converter 208, segments B and D sent to STT converter 212), all segments with non-sensitive information sent to the same STT converter 208, while each segment with some sensitive information is sent to a unique or different STT converter (e.g., segments A, B, and E including only non-sensitive information sent to STT converter 208, segment C (including partial sensitive info) sent to STT converter 210, and segment D (including partial sensitive info) sent to STT converter 212). Other combinations are possible as well, so long as all of the sensitive information is not sent to the same STT converter. Although segments A-E are referred to, the figures show only segments A and B to avoid overcomplicating the figures.

At 414A and 414B, each respective STT converter converts the respective second user voice input segment into a second user text input segment. As shown in FIG. 4, STT converter 208 converts segment A, and STT converter 212 converts segment B. At 416A and 416B, the second user text input segments generated by the respective STT converters 208 and 212 are sent to the target service 206.

At 418, the target service 206 joins the second user text input segments into a second user text input. At 420, the target service 206 performs processing on the second user text input to correct any issues or errors in the conversion process. For example, the target service 206 may replace words that were incorrectly converted (e.g., with the correct homonym), add or change punctuation, add or change syntax, and more. After joining the second user text input segments, the target service 206 may have a better understanding of the full context of the second user text input that was missing at each of the STT converters, allowing the target service 206 to correct mistakes in the conversion.

At 422, the target service 206 analyzes the second user text input and performs a corresponding action. The action may include, for example, accessing account information for the user based on a received account number; determining a diagnosis based on symptoms identified in second user text input; identifying additional questions to ask the user; etc. The analysis may include using an AI-driven chatbot to provide services to the user.

FIG. 5 illustrates a portion of the process following that shown in FIG. 4. In particular, FIG. 5 illustrates the steps in the process following 422 of FIG. 4, in which the target service 206 analyzes the second user text input to determine the appropriate response. That is, once the target service 206 analyzes the second user voice input and converts it to a second user text input (as shown in FIG. 4), FIG. 5 illustrates how the target service 206 generates a second voice response and transmits it to the user device 202. At a relatively high level, FIG. 5 illustrates how the target service 206 determines a second text response based on the second user text input (analyzed at step 422), splits or divides the second text response into a plurality of second text response segments, and converts the plurality of second text response segments into corresponding second voice response prompts using a plurality of different TTS converters. The target service 206 then combines the plurality of second voice response prompts to generate a second voice response, which it transmits to the user device 202 to be presented to the user.

At 502, the target service 206 generates a second text response, based on the second user text input analyzed at step 422 of FIG. 4. The second text response may include sensitive information, questions for the user, and/or various other information.

At 504, the target service 206 splits or divides the second text response into a plurality of second text response segments. In the illustrated example, there are two second text response segments, segment A and segment B. However, it should be appreciated that the second text response may be split into any number of segments, and FIG. 5 includes two segments for illustrative purposes only. The target service 206 may split the second text response into segments based on the content of second text response. For example, if the second text response includes sensitive information, the target service 206 may split the second text response to ensure that the sensitive information is split between two or more different segments, and no single segment includes all of the sensitive information. In some embodiments, the target service 206 may perform pre-processing on the second text response to identify sensitive information based on detecting certain terms, certain categories of information, an account balance, symptoms of a health problem, etc. The target service 206 may then identify the best positions in the second text response for segmentation. In some embodiments, the target service 206 may split the second text response based on the length of the second text response, the number of TTS converters available, the length or amount of sensitive information in the second text response, the placement of sensitive information within the second text response, or based on some other criteria.

At 506A and 506B, the target service 206 transmits the second text response segments to the TTS converters 216 and 218, respectively. In the illustrated example of FIG. 5, second text response segment A is transmitted to TTS converter 216, and second text response segment B is transmitted to TTS converter 218. It should be appreciated that other numbers of segments and TTS converters may be used. Additionally, the subset of available TTS converters used may change over time, and may be different for each response by the target service. That is, while the first text response segments were converted using TTS converters 214 and 216 (see FIG. 3), the second text response segments may be converted using TTS converters 216 and 218, as shown in FIG. 5.

In some embodiments, the target service 206 may transmit the second text response segments to the TTS converters along with one or more output parameters. The output parameters may specify one or more characteristics of the conversion process, to ensure that there is continuity of voice, tone, pitch, volume, accent, etc., in the resulting voice response.

At 508A and 508B, the TTS converters 216 and 218 convert the second response text segments into respective second response voice prompts. And at 510A and 510B, the TTS converters transmit the second response voice prompts to the target service 206.

At 512, the target service 206 joins the plurality of second response voice prompts into a second voice response, such as by concatenation. The target service 206 may also perform post-processing of the second response voice prompts, and/or the second voice response (once the voice prompts are joined). Because different TTS converters may have different parameters, and/or because each TTS converter operates only on one segment of the full second response, the conversion process and joining of the second response voice prompts may add errors or artifacts such as different length pauses after segments, or awkward spacing of words. Post-processing by the target service 206 may remove these errors or artifacts and ensure uniformity of the second voice response.

At 514, the target service 206 then transmits the second voice response to the user device 202. The user device 202 may then present the second voice response to the user via a speaker or other suitable output mechanism. The conversation between the user device 202 and the target service 206 may then continue back and forth, with additional user voice inputs and target service responses. The steps shown in FIGS. 4 and 5 may be repeated until the conversation is complete, and/or the user or target service ends the conversation.

The example illustrated in FIGS. 2-5 includes the target service performing segmentation of the user voice input. That is, the user voice input is received at the user device, and then transmitted to the target service along with candidate locations for segmentation, and then the target service itself performs the segmentation. However, in some embodiments, the user device itself may perform segmentation. In other embodiments, both the user device and the target service may perform segmentation, or may perform partial segmentation (e.g., the user device performs a first segmentation, and the target service performs a subsequent additional segmentation).

In some embodiments, segmenting the user voice inputs and/or the target service text responses (prior to conversion using the STT converters or TTS converters) may include generating equal-sized segments or different-sized segments. In some cases, the segment size may depend on the overall voice input or text response length prior to segmentation, the complexity of the voice input or text response, the processing power available at the target service, the presence and/or positioning of sensitive information within the voice input or text response, the length of the sensitive information, and more. In some embodiments, the number of segments generated may be as small as two, or as large as 20 or more, depending on various factors.

To perform the STT and TTS conversion, the example shown in FIGS. 2-5 includes the use of two converters for a given message. However, it should be appreciated that the number of STT and/or TTS converters may be greater than two, and/or may change depending on the number of segments. Additionally, the number of STT and/or TTS converters may change over the course of a given conversation, such that a first voice input from the user is converted using a different number of STT converters than a second voice input from the user, and/or a first text response from the target service is converted using a different number of TTS converters than a second text response from the target service. The number of STT and/or TTS converters used may depend on the number of segments to be converted, the length of the voice input or text response, the content of the voice input or text response (e.g., whether there is sensitive information or not, where the sensitive information is positioned in the voice input or text response, the length or amount of sensitive information, etc.). In some embodiments, the number of STT and/or TTS converters used may be selected initially based on a default value. The number of converters used may remain constant during the conversation. In other embodiments, the number of converters used may change over time. In some embodiments, each converter may receive the same size segment for conversion, while in other embodiments one or more converters may receive a different size segment from one or more other converters. In some embodiments, the number of TTS and/or STT converters used, and/or which subset of available converters to use, used may be selected by the user, by the target service, by some other entity, or by any combination thereof. In still other examples, a random number generator or other data may be used to determine the number of converters and/or the subset of converters to be used.

The example illustrated in FIGS. 2-5 includes transmitting each segment to the STT and/or TTS converters simultaneously. In other embodiments, one or more segments may be transmitted in series. That is, a first segment may be converted before a second segment is converted. Additionally, one or more converters may be used to convert multiple segments. For example, if there are four segments (A, B, C, and D) and only three converters, segments A, B, and C may be sent to converters 1, 2, and 3 simultaneously, and segment D may be sent to converter 1 after converter 1 has finished converting segment A. In other embodiments, non-adjacent segments may be sent to the same converter. For example, segments A and B may be sent to converters 1 and 2 respectively, and then after the conversion of segments A and B is finished, segments C and D may be sent to converters 1 and 2. As a result, converter 1 may convert segment A then segment C, while converter 2 converts segment B then segment D.

In some embodiments, the target service itself may comprise or may control one or more TTS and/or STT converters. In this case, the target service itself may perform some or all of the STT conversion and/or TTS conversion. For example, if the target service includes its own TTS converter, the target service may convert an entire text response to a voice response on its own, without first performing segmentation. However, if the target service does not include its own STT converter, the target service may still use multiple independent STT converters to convert a user voice input into text. Similarly, if the target service includes its own STT converter, the target service may convert an entire user voice input into a user text input on its own, without first performing segmentation. However, if the target service does not include its own TTS converter, the target service may still use multiple independent TTS converters to convert text response into a voice response.

In some embodiments, the voice assistant service (e.g., voice assistant service 120 of FIG. 1, or 204 of FIG. 2) may act as the target service as well. In this case, the voice assistant service may perform one or more of the functions described herein with respect to the target service, such as segmenting the user inputs and response text, and using multiple TTS and/or STT converters.

Throughout the disclosure, various messages and data are described as being transmitted or sent between various devices and systems. It should be appreciated that one or more of these messages may include the use of encryption. The user device, target service, STT and TTS converters, and other devices or systems may use one or more cryptographic techniques to generate, and/or share, private keys, public keys, symmetric keys, and/or shared secrets and/or other data for encryption and/or decryption of messages and/or other data.

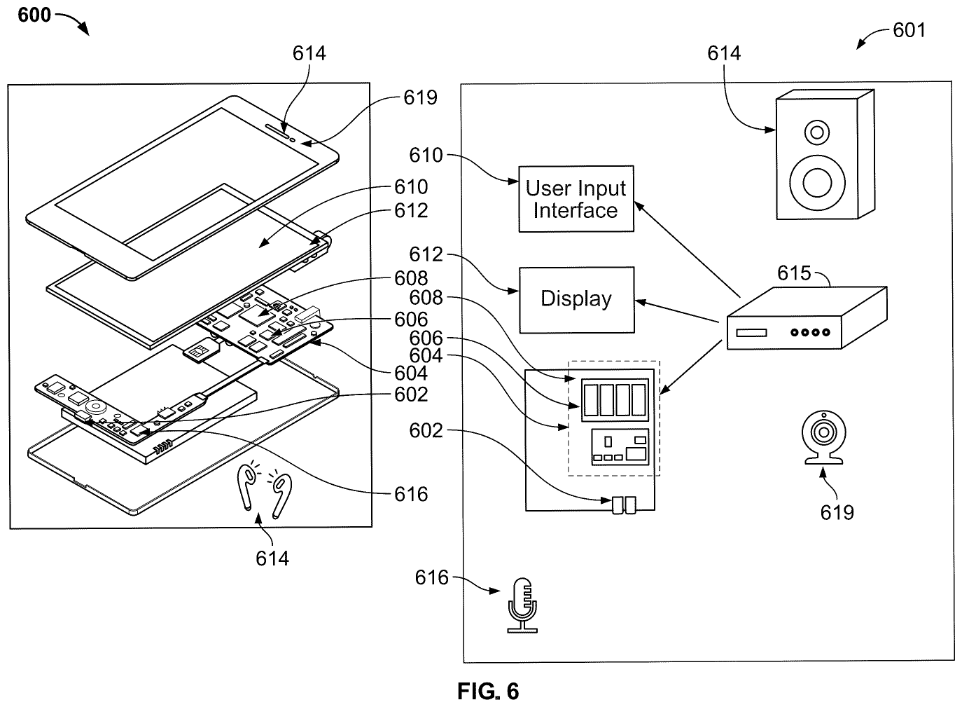

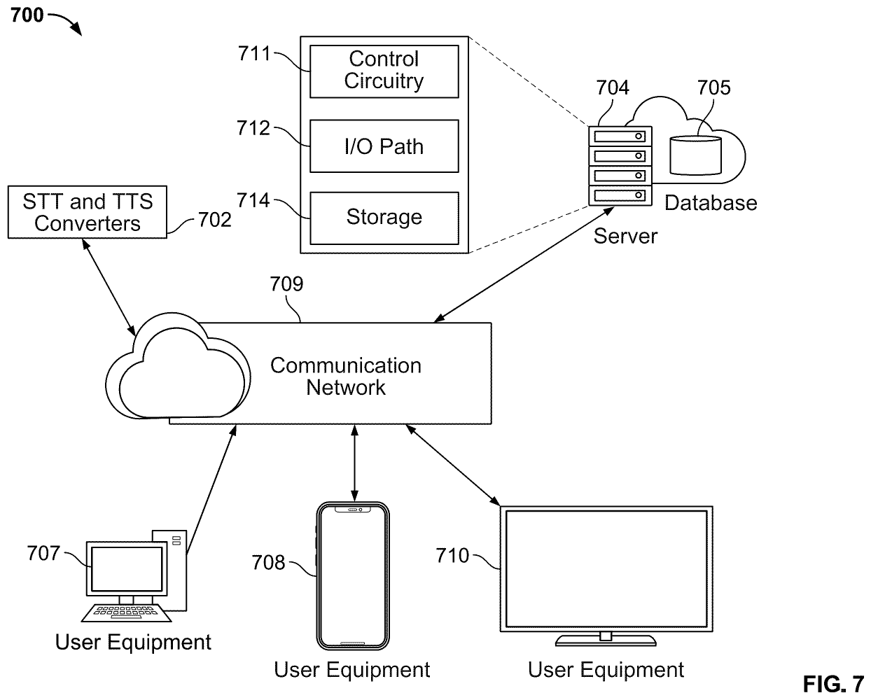

FIGS. 6-7 depict illustrative devices, systems, servers, and related hardware for performing the functions described herein, in particular for enabling a conversation between a user device and a target service using enhanced privacy. FIG. 6 shows generalized embodiments of illustrative computing devices 600 and 601, which may correspond to, e.g., user devices 110 and 202, voice assistant services 120 and 204, target services 130 and 206, STT converters 150 and 208-212, and/or TTS converters 140 and 214-218, described with respect to FIGS. 1-5 and 8. For example, computing device 600 may be a smartphone device, a tablet, a voice assistant device (e.g., Google Home or Amazon Alexa device), or any other suitable device capable of receiving user voice inputs, communicating with a target service via a communication channel, and presenting voice responses from the target service to the user. In another example, computing device 601 may be laptop computer, desktop computer, server, or other computer system or device capable of performing the functions of the voice assistant service and/or target service described herein. Computing devices 601 may include computing system 615. Computing system 615 and/or computing device 600 may be communicatively connected to or may include microphone 616, audio output equipment (e.g., speaker or headphones 614), and display 612. In some embodiments, microphone 616 may receive audio corresponding to a user voice input. In some embodiments, display 612 may be a television display or a computer display. In some embodiments, computing system 615 and/or computing device 600 may be communicatively connected to or may include a user input interface 610. In some embodiments, user input interface 610 may be a remote control device. Computing system 615 and/or computing device 600 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 7. In some embodiments, computing devices 600 and/or 601 may comprise any suitable number of sensors (e.g., gyroscope or gyrometer, or accelerometer, etc.), and/or a GPS module (e.g., in communication with one or more servers and/or cell towers and/or satellites) to ascertain a location of computing devices 600 and/or 601. In some embodiments, computing devices 600 and/or 601 may comprise a rechargeable battery that is configured to provide power to the components of the computing device.

Each one of computing device 600 and computing device 601 may receive content and data via input/output (I/O) path 602. I/O path 602 may provide information (e.g., user voice inputs and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing. While computing system 615 is shown in FIG. 6 for illustration, any suitable computing device having processing circuitry, control circuitry, and storage may be used in accordance with the present disclosure. For example, computing system 615 may be replaced by, or complemented by, a personal computer (e.g., a notebook, a laptop, a desktop), a smartphone (e.g., computing device 600), an XR device, a tablet, a network-based server hosting a user-accessible client device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for the virtual meeting system stored in memory (e.g., storage 608). Specifically, control circuitry 604 may be instructed by the virtual meeting system to perform the functions discussed above and below. In some implementations, processing or actions performed by control circuitry 604 may be based on instructions received from a communication application configured to carry out the functions described herein.

In client/server-based embodiments, control circuitry 604 may include communications circuitry suitable for communicating with a server or other networks or servers. The communication application configured to carry out the functions described herein may be a stand-alone application implemented on a computing device or a server. The communication application may be implemented as software or a set of executable instructions. The instructions for performing any of the embodiments discussed herein of the communication application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a computing device 600 or 601.

In some embodiments, the communication application may be a client/server application where only the client application resides on computing device 600 or 601, and a server application resides on an external server (e.g., server 704 of FIG. 7). For example, the communication application configured to carry out the functions described herein may be implemented partially as a client application on control circuitry 604 of computing device 600 and partially on server 704 as a server application running on control circuitry 711. Server 704 may be a part of a local area network with one or more of computing devices 600, 601 or may be part of a cloud computing environment accessed via the internet. In a cloud computing environment, various types of computing services are provided by a collection of network-accessible computing and storage resources (e.g., server 704 and/or an edge computing device), referred to as “the cloud.” Computing device 600 may be a cloud client that relies on the cloud computing capabilities from server 704 to perform various functions described herein.

When executed by control circuitry of server 704, the communication application may instruct control circuitry 711 to perform such tasks. The client application may instruct control circuitry 604 to determine such tasks.

Control circuitry 604 may include communications circuitry suitable for communicating with target service computing device or system, and/or other networks, devices, or servers. The instructions for carrying out the above mentioned functionality may be stored on a server (which is described in more detail in connection with FIG. 7). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 7). In addition, communications circuitry may include circuitry that enables peer-to-peer communication of computing devices, or communication of computing devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of information, messages, recordings, etc. described herein. Nonvolatile memory may also be used (e.g., to launch a boot-up routine and other instructions). Cloud-based storage may be used to supplement storage 608 or instead of storage 608.

Control circuitry 604 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 604 may also include scaler circuitry for upconverting and downconverting content into the preferred output format of computing device 600. Control circuitry 604 may also include digital-to-analog converter circuitry and analog-to-digital converter circuitry for converting between digital and analog signals. The tuning and encoding circuitry may be used by computing devices 600 and/or 601 to receive and to display, to play, or to record messages, responses, voice inputs, and more. The circuitry described herein, including for example, the tuning, encoding, decoding, encrypting, decrypting, scaler, and analog/digital circuitry, may be implemented using software running on one or more general purpose or specialized processors. Multiple tuners may be provided to manage simultaneous tuning functions (e.g., watch and record functions, picture-in-picture (PIP) functions, multiple-tuner recording, etc.). If storage 608 is provided as a separate device from computing device 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of computing device 600 and computing device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice inputs and/or voice commands and transmit information to computing system 615.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of computing device 600 and computing device 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone, then analyzed and/or converted to text by control circuitry 604. In a further example, a user may voice commands that are received by a microphone and recognized by control circuitry 604. Camera 619 may be any suitable video camera integrated with the equipment or externally connected. Camera 619 may be a digital camera comprising a charge-coupled device (CCD) and/or a complementary metal-oxide semiconductor (CMOS) image sensor. Camera 619 may be an analog camera that converts to digital images via a video card.

The communication application configured to carry out the functions described herein may be implemented using any suitable architecture. For example, it may be a stand-alone application wholly implemented on each one of computing device 600 and computing device 601. In such an approach, instructions of the application may be stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to carry out the functions described herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 604 may allow a user to provide user profile information or may automatically compile user profile information. For example, control circuitry 604 may access and monitor network data, video data, audio data, processing data, participation data from a conference participant profile. Control circuitry 604 may obtain all or part of other user profiles that are related to a particular user (e.g., via social media networks), and/or obtain information about the user from other sources that control circuitry 604 may access. As a result, a user can be provided with a unified experience across the user's different devices.

In some embodiments, the communication application configured to carry out the functions described herein is a client/server-based application. Data for use by a thick or thin client implemented on each one of computing device 600 and computing device 601 may be retrieved on-demand by issuing requests to a server remote to each one of computing device 600 and computing device 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on computing device 600. This way, the processing of the instructions is performed remotely by the server while the resulting displays (e.g., that may include text, a keyboard, or other visuals) are provided locally on computing device 600. Computing device 600 may receive inputs from the user via input interface 610 and transmit those inputs to the remote server for processing and generating the corresponding displays. For example, computing device 600 may transmit a communication to the remote server indicating that an up/down button was selected via input interface 610. The remote server may process instructions in accordance with that input and generate a display of the application corresponding to the input (e.g., a display that moves a cursor up/down). The generated display may then be transmitted to computing device 600 for presentation to the user.

In some embodiments, the communication application may be downloaded and interpreted or otherwise run by an interpreter or virtual machine (run by control circuitry 604). In some embodiments, the communication application may be encoded in the ETV Binary Interchange Format (EBIF), received by control circuitry 604 as part of a suitable feed, and interpreted by a user agent running on control circuitry 604. For example, the communication application may be an EBIF application. In some embodiments, the communication application may be defined by a series of JAVA-based files that are received and run by a local virtual machine or other suitable middleware executed by control circuitry 604. In some of such embodiments (e.g., those employing MPEG-2, MPEG-4, HEVC or any other suitable digital media encoding schemes), portions of the communication application (e.g., recordings) may be, for example, encoded and transmitted in an MPEG-2 object carousel with the MPEG audio and video packets of a program.

As shown in FIG. 7, devices 707, 708, and 710 may be coupled to communication network 709. In some embodiments, each of computing devices 707, 708, and 710 may correspond to one of computing devices 600 or 601 of FIG. 6, or any other suitable device capable of performing the functions of the user device and/or target service as described above. Communication network 709 may be one or more networks including the Internet, a mobile phone network, mobile, voice or data network (e.g., a 5G, 4G, or LTE network), cable network, public switched telephone network, or other types of communication network or combinations of communication networks. Paths (e.g., depicted as arrows connecting the respective devices to the communication network 709) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between the user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 709.

System 700 may comprise STT and TTS converters 702, one or more servers 704, and/or one or more edge computing devices. In some embodiments, the target service described elsewhere with respect to FIGS. 1-5 and 8 may comprise or correspond to the one or more servers 704. In some embodiments, the communication application may be executed at one or more of control circuitry 711 of server 704 (and/or control circuitry of computing devices 707, 708, 710 and/or control circuitry of one or more edge computing devices). In some embodiments, server 704 may be configured to host or otherwise facilitate communication sessions with and/or between computing devices 707, 708, 710 and/or any other suitable devices, and/or host or otherwise be in communication (e.g., over network 709) with one or more social network services.

In some embodiments, server 704 may include control circuitry 711 and storage 714 (e.g., RAM, ROM, Hard Disk, Removable Disk, etc.). Storage 714 may store one or more databases. Server 704 may also include an input/output path 712. I/O path 712 may provide various information, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 (and specifically control circuitry) to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i5 processor and an Intel Core i7 processor).

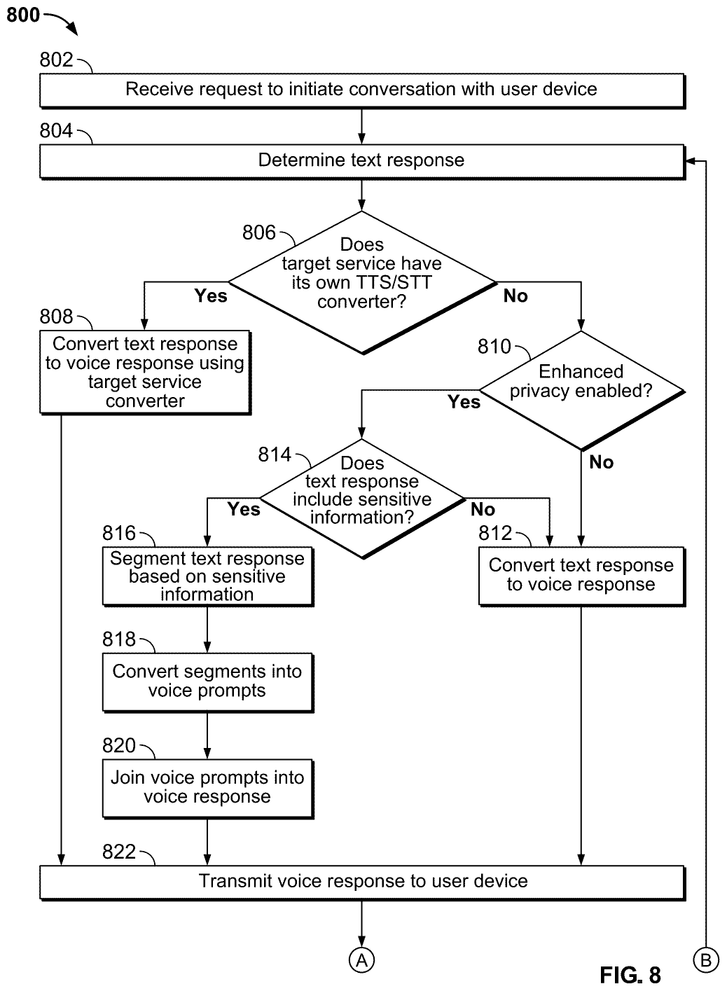

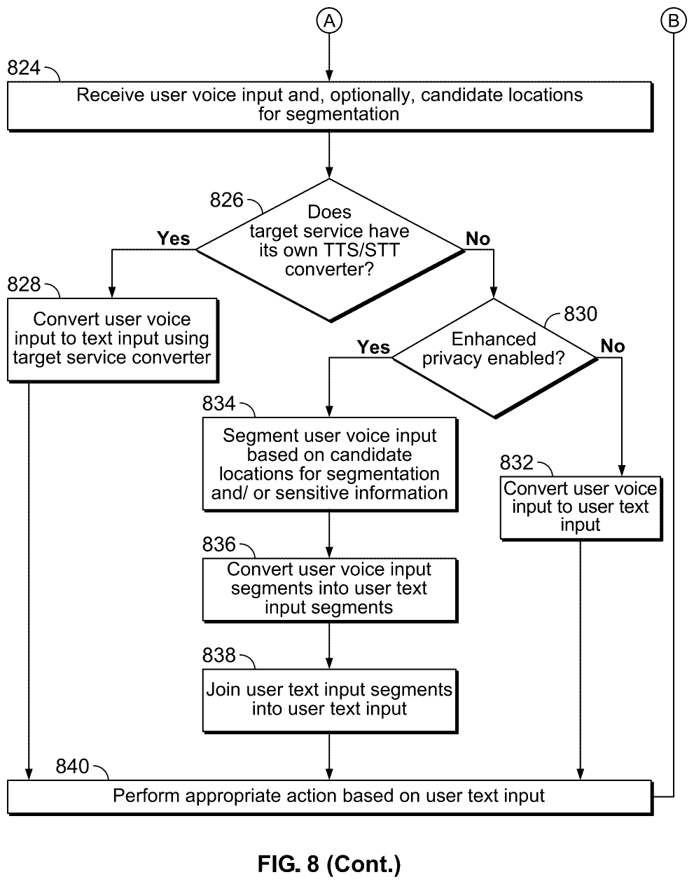

FIG. 8 is an example flowchart of a process 800 for communicating between a target service and a user device operated by a user with the user's voice, in accordance with some examples of the disclosure. The process 800 may be implemented, in whole or in part, by the devices and systems shown in FIGS. 1-7. One or more actions of the process 800 may be incorporated into or combined with one or more actions of any other process or embodiments described herein. The process 800 may be saved to a memory or storage (such as any one or more of those shown in FIGS. 6-7) as one or more instructions or routines that may be executed by a corresponding device or system to implement the process 800.

At step 802, a target service, such as target service 206, receives a request to initiate a conversation with a user device (e.g., input 160 of FIG. 1). As noted above with respect to FIGS. 1 and 2, the request may be received from a voice assistant service (e.g., Amazon) or a voice assistant device, in which case the voice assistant service or device acts as an intermediary for an initial voice input from a user. Where the request is received from the voice assistant device, the voice assistant service may provide relevant information to a voice assistant device (e.g., IP address, parameters of an API call, etc.) of the target service. For instance, a user voice input may include a wake word and a target service identifier, with the intent to begin a conversation with the target service. The target service may then establish a communication channel with the user device.

At step 804, the target service may determine a text response. This response may be a generic greeting such as “How may I help you?”

At step 806, the target service may determine whether it has access to its own TTS and/or STT converter. If the target service does have its own converter, then there is no need for additional converters to be used. Since the target service has all of the user's confidential information anyway, and because the target service operates the converter, the target service can perform the conversion itself without needing to split any sensitive information in the response into separate segments.

If the target service does have its own converter, at step 808 the target service converts the text response to a voice response using the target service converter. The process 800 then proceeds to step 822.

If the target service does not have its own converter, at step 810 the target service may determine whether enhanced privacy is enabled. The user may enable enhanced privacy via the voice input, by a selection or default option, or in some other way, as discussed above. In some embodiments, enhanced privacy may be automatically enabled based on detecting that the user input includes sensitive information, and/or based on the nature or category of the target service.

If enhanced privacy is not enabled, at step 812 the target service may convert the text response into a voice response, such as by using a single TTS converter. The target service may perform the conversion itself (e.g., as in step 808), or the text response may be converted by a different or separate converter without performing segmentation or analysis of the response to identify any sensitive information.

If, at step 810, the target service determines that enhanced privacy is enabled, step 814 may include determining whether the text response includes any sensitive information. In some embodiments, enhanced privacy may apply only to responses and user inputs that include sensitive information. If the response or user input does not include sensitive information, that response or user input may be converted using a single TTS and/or STT converter. For example, if at step 814 it is determined that there is no sensitive information in the text response from the target service, the process 800 may proceed to step 812 to convert the text response to a voice response using a converter without segmenting or splitting the text response into segments.

However, if at step 814 it is determined that there is sensitive information, step 816 may include segmenting the text response. The text response may be analyzed to determine which portions of the text response include sensitive information (e.g., user account information, health information, user profile information, etc.). This analysis may include comparing the text response content to keywords that signal confidential information (e.g., “credit score,” “diagnosis,” “account number,” etc.). The target service may then split or divide the text response into segments based on the position of this sensitive information within the text response, such that the sensitive information is split into two or more different segments.

At step 818, the text response segments (e.g., segments 164 in FIG. 1) are converted into respective voice response segments (e.g., segments 166 in FIG. 1). This may include using multiple different TTS converters, such that no single converter is provided with all of the sensitive information in the response. At step 820, the target service receives the respective voice response segments and joins them together into a voice response. This may also include performing pre-and/or post-processing to ensure that the voice response does not include any awkward pauses or other discrepancies caused by using multiple independent TTS converters.

At step 822, the voice response (e.g., response 168 in FIG. 1) is transmitted to the user device. The user device may then present the voice response to the user. The user may then input a user voice input, answering any question posed in the voice response from the target service, or asking a question or issuing a command to the target service. The user device may then transmit the user voice input to the target service. In some embodiments, the user device may also analyze the user voice input to identify one or more candidate locations for segmentation of the user voice input. This information may also be transmitted to the target service.

At step 824, the target service receives the user voice input, and if applicable, the candidate locations for segmentation. The target service may then determine whether it has access to its own STT converter at step 826. As with step 806 above, if the target service does have its own converter, then there is no need for additional converters to be used. Since the target service has all of the user's confidential information anyway, and because the target service operates the converter, the target service can perform the conversion itself without needing to split any sensitive information in the response into separate segments. If the target service does have its own converter, at step 828, the target service converts the user voice input to a text input using the target service converter. The process 800 then proceeds to step 840.

If the target service does not have its own converter, at step 830 the target service may then determine whether enhanced privacy is enabled. If enhanced privacy is not enabled, the process 800 may proceed to step 832 at which the target service converts the user voice input to a user text input. This may include converting the user voice input using a single STT converter, without performing segmentation of the user voice input.

If, however, the target service determines at step 830 that enhanced privacy is enabled, the target service may perform segmentation of the user voice input at step 834. The segmentation may include splitting the user voice input into segments based on the candidate locations for segmentation that were received at step 824. Additionally or alternatively, the target service may segment the user voice input based on any sensitive information included in the user voice input, such that the sensitive information is split into multiple different segments.

At step 836, the user voice input segments (e.g., segments 172 in FIG. 1) are converted into user text input segments (e.g., segments 174 in FIG. 1) by a plurality of different STT converters. The STT converters may be independently controlled from each other, such that no single converter or entity controlling one or more of the converters has access to the entire user voice input, or to all of the sensitive information included in the user voice input. At step 838, the target service then joins together the plurality of user text input segments to generate a user text input. In some embodiments, the target service may also perform post-processing of the text input segments. For instance, the target service may use AI or an NLP-based processing step to correct any errors in the user text input that arose from the fact that each segment was independently converted. The post-processing may correct errors in word selection (e.g., selecting the appropriate homonym), as well as other errors to ensure that the correct context is retained.

At step 840, the target service analyzes the user text input and determines the next action to perform in response. This may include looking up information about the user, preparing follow-up questions, or taking some other action. The target service may determine a text response to send to the user and proceed back to step 804. The process 800 may continue in a loop, performing steps 804-840 until the conversation between the user device and target service is complete.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings), may be replaced by alternative features serving the same, equivalent, or similar purpose unless expressly stated otherwise. Thus, unless expressly stated otherwise, each feature disclosed is one example only of a generic series of equivalent or similar features.

The invention(s) are not restricted to the details of any foregoing embodiments. The invention(s) extend to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing embodiments, but also any embodiments that fall within the scope of the claims.

Throughout the description and claims of this specification, the words “comprise” and “contain” and variations of them mean “including but not limited to,” and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

All of the features disclosed in this specification (including any accompanying claims, abstract, and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract, and drawings), or to any novel one, or any novel combination, of the steps of any method or process so disclosed.

The reader's attention is directed to all papers and documents that are filed concurrently with or previous to this specification in connection with this application and that are open to public inspection with this specification, and the contents of all such papers and documents are incorporated herein by reference.

1. A method comprising:
receiving, by a target service, a first user voice input;
generating, by the target service, a first voice response in relation to the first user voice input;
transmitting the first voice response to a user device, wherein the first voice response is transmitted to the user device via a connection established by a voice assistant service between the user device and the target service;
receiving, from the user device, a second user voice input;
generating, by the target service, a second user text input in relation to the second user voice input, wherein generating the second user text input comprises:
generating a plurality of second user voice input segments based on the second user voice input;
transmitting each respective second user voice input segment of the plurality of second user voice input segments to a different speech-to-text converter, wherein the different speech-to-text converters generate a plurality of second user text input segments; and
combining the plurality of second user text input segments to generate the second user text input;
generating, by the target service, a second voice response in relation to the second user text input; and
transmitting the second voice response to the user device.

2. The method of claim 1, further comprising:
receiving, by the target service from the voice assistant service, a request to initiate a conversation between the user device and the target service, wherein the first user voice input comprises the request to initiate the conversation.

3. The method of claim 1, wherein the first user voice input comprises a wake phrase and a target service identifier, and wherein the target service is identified based on the target service identifier in the first user voice input.

4. The method of claim 1, wherein generating the first voice response comprises:
determining a first text response;
segmenting the first text response into a plurality of first text response segments;
transmitting each respective first text response of the plurality of first text response segments to a different text-to-speech converter, wherein the different text-to-speech converters generate a plurality of first voice response prompts; and
combining the plurality of first voice response prompts to generate the first voice response.

5. The method of claim 4, wherein segmenting the first text response into the plurality of first text response segments comprises:
identifying sensitive information in the first text response, the sensitive information comprising a first portion and a second portion that do not overlap; and
segmenting the first text response such that the first portion of the sensitive information is included in a first segment of the plurality of first text response segments, and the second portion of the sensitive information is included in a second segment of the plurality of first text response segments.

6. The method of claim 4, wherein transmitting each of the plurality of first text response segments to the different text-to-speech converters, to generate the plurality of first voice response prompts further comprises:
transmitting output parameters along with the plurality of first text response segments, wherein the output parameters enable continuity between the plurality of first voice response prompts.

7. The method of claim 4, further comprising:
determining whether the target service comprises a text-to-speech converter; and
in response to determining that the target service does not comprise a text-to-speech converter, generating, by the target service, the first voice response using the different text-to-speech converters.

8. The method of claim 1, further comprising:
determining whether the target service comprises a speech-to-text converter; and
in response to determining that the target service does not comprise a speech-to-text converter, generating, by the target service, the second user text input using the different speech-to-text converters.

9. The method of claim 1, further comprising:
determining whether a request to enable enhanced privacy for the connection between the user device and the target service has been received; and
in response to determining that the request to enable enhanced privacy has been received:
transmitting each of the plurality of second user voice input segments to the different speech-to-text converters.

10. The method of claim 1, further comprising:
receiving, from the user device, (1) the second user voice input and (2) one or more candidate locations in the second user voice input for segmentation; and
generating the plurality of second user voice input segments by segmenting the second user voice input based on the one or more candidate locations in the second user voice input for segmentation received from the user device.

11. The method of claim 10, wherein the one or more candidate locations in the second user voice input for segmentation are determined based on an analysis of the second user voice input using voice activity detection or pause detection, and wherein the one or more candidate locations in the second user voice input for segmentation are stored as metadata of the second user voice input.

12. The method of claim 1, wherein generating, by the target service, the second voice response comprises:
determining a second text response based on the second user text input;
segmenting the second text response into a plurality of second text response segments;
transmitting each of the plurality of second text response segments to a different text-to-speech converter, wherein the different text-to-speech converters generate a plurality of second response voice prompts; and
combining the plurality of second response voice prompts to generate the second voice response.

13. The method of claim 12, wherein a number of different text-to-speech converters used in generating the second voice response differs from a number of different text-to-speech converters used in generating the first voice response.

14. The method of claim 1, further comprising:
receiving, from the user device, an indication of a set of speech-to-text converters; and
transmitting each respective second user voice input segment of the plurality of second user voice input segments to a different speech-to-text converter of the set of speech-to-text converters.

15. A system comprising:
input/output circuitry configured to receive, at a target service, a first user voice input; and
control circuitry configured to:
generate a first voice response in relation to the first user voice input;
transmitting the first voice response to a user device, wherein the first voice response is transmitted to the user device via a connection established by a voice assistant service between the user device and the target service;
wherein the input/output circuitry is further configured to receive, from the user device, a second user voice input;
wherein the control circuity is further configured to:
generate a second user text input in relation to the second user voice input, wherein generating the second user text input comprises:
generating a plurality of second user voice input segments based on the second user voice input;
transmitting each respective second user voice input segment of the plurality of second user voice input segments to a different speech-to-text converter, wherein the different speech-to-text converters generate a plurality of second user text input segments; and
combining the plurality of second user text input segments to generate the second user text input; and
generate a second voice response in relation to the second user text input; and
wherein the input/output circuitry is further configured to transmit the second voice response to the user device.

16. The system of claim 15, wherein the input/output circuitry is further configured to:
receive, at the target service from the voice assistant service, a request to initiate a conversation between the user device and the target service, wherein the first user voice input comprises the request to initiate the conversation.

17. The system of claim 15, wherein the first user voice input comprises a wake phrase and a target service identifier, and wherein the target service is identified based on the target service identifier in the first user voice input.

18. The system of claim 15, wherein the control circuitry is configured to generate the first voice response by:
determining a first text response;
segmenting the first text response into a plurality of first text response segments;
transmitting each respective first text response of the plurality of first text response segments to a different text-to-speech converter, wherein the different text-to-speech converters generate a plurality of first voice response prompts; and
combining the plurality of first voice response prompts to generate the first voice response.

19. The system of claim 18, wherein the control circuitry is configured to segment the first text response into the plurality of first text response segments by:
identifying sensitive information in the first text response, the sensitive information comprising a first portion and a second portion that do not overlap; and
segmenting the first text response such that the first portion of the sensitive information is included in a first segment of the plurality of first text response segments, and the second portion of the sensitive information is included in a second segment of the plurality of first text response segments.

20. The system of claim 18, wherein the control circuitry is further configured to transmit output parameters along with the plurality of first text response segments, wherein the output parameters enable continuity between the plurality of first voice response prompts.

21-70. (canceled)
